(19) United States
(12) Patent Application Publication
(10) Pub. No.: US 2003/0001822 A1
(43) Pub. Date: Jan. 2, 2003

(54) Keyboard with integrated mouse/pointer device

(76) Inventors: Brian Davidson, Surrey (GB); Nikolaj Helberg Bestle, Calabasas, CA (US)

Correspondence Address: JERALD J. GNUSCHKE, NOKIA INC., 6000 CONNECTION DRIVE, MD 1-4-755, IRVING, TX, 75039, US

(21) Appl. No.: 09/896,693

(22) Filed: Jun. 29, 2001

(51) Int. Cl. G09G 5/00

(52) U.S. Cl. 345/168

(57) ABSTRACT

A data input device for use with portable electronic devices. The data input device has a motion-sensing device disposed within it that detects movement of the input device. In the presently preferred embodiment, the data input device has at least a keypad and an integral mouse-ball system.

### FIELD OF THE INVENTION

This invention relates to input devices and, more particularly, to keyboards with integrated positioning devices.

### BACKGROUND

Mobile communication devices generally have a data input device such as a keyboard. The data input device is typically an integral part of the mobile communication device. For example, in a conventional mobile cellular telephone, the keypad is physically a part of the cellular telephone.

Due to the small size of most mobile communication devices, integral data input devices are generally small and difficult to use. For example, the typical cellular telephone keypad is constrained by the size of the cellular telephone. As future cellular telephones continue to get smaller, so too must their integral keypads. As the keypads become ever smaller, they become more difficult to manipulate. Thus, it would be advantageous to have an external keypad/keyboard to function as a remote data entry device for small mobile communication devices.

FIG. 1 shows a conventional keyboard 100 and mouse 110 as they are typically used with a personal computer 120. The mouse 110 and the keyboard 100 are physically separate devices. Using both devices can be difficult in constrained areas, such as in coach class passenger seating aboard the typical commercial airplane. Thus, it would be advantageous to combine the two devices in order to save space.

Past efforts to combine the keyboard with a device for use with graphical interfaces have resulted in inventions such as the keyboard/trackball and the keyboard/trackpoint (a type of joystick found in the keyboard of IBM laptop computers). Both of these solutions suffer from the disadvantage that the user must move his fingers from the keys to operate the trackball or trackpoint, which slows typing. Thus, it would be an advantage to combine a keyboard with a device for navigating graphical user interfaces so that the user does not have to remove his fingers from the keys of the keyboard when navigating the graphical user interface.

### SUMMARY OF THE INVENTION

Various embodiments of the invention disclose a data input device with an integral motion-sensing device. The motion-sensing device detects movement of the data input device and generates data that, among other uses, can be used to navigate a graphical user interface on a remote data processing device.

The presently preferred embodiment of the invention is a keyboard for use with a mobile communication device such as a cellular mobile phone, the keyboard having an integral mouse-like motion-sensing device. The motion-sensing device is disposed within the keyboard and senses movement of the keyboard (unlike a trackball or trackpoint, which are unable to detect movement of the keyboard).

Embodiments of the disclosed invention advantageously function as a remote data input device with a mouse disposed primarily within the remote data input device. Embodiments of the disclosed invention are also beneficial for users who wish to avoid the distraction of removing their fingers from the keys to manipulate a device that operates a graphical user interface.

### BRIEF DESCRIPTION OF THE DRAWINGS

The disclosed inventions will be described with reference to the accompanying drawings, which show important sample embodiments of the invention and which are incorporated in the specification hereof by reference, wherein:

FIG. 1 shows a prior art situation in which a keyboard and a separate mouse are used with a computer.

FIG. 2A depicts a top view of the presently preferred embodiment of a data input device capable of implementing the disclosed innovations.

FIG. 2B depicts a side view of the presently preferred embodiment of a data input device capable of implementing the disclosed innovations.

FIG. 3 depicts an embodiment of the innovative data input device as it might be used with a remote device.

FIG. 4 depicts an internal block diagram of the presently preferred embodiment of a data input device capable of implementing the disclosed innovations.

FIG. 5 shows a block diagram of a mobile station capable of interacting with the presently preferred embodiment.

FIG. 6 shows an embodiment of the present invention in use with a mobile communication device.

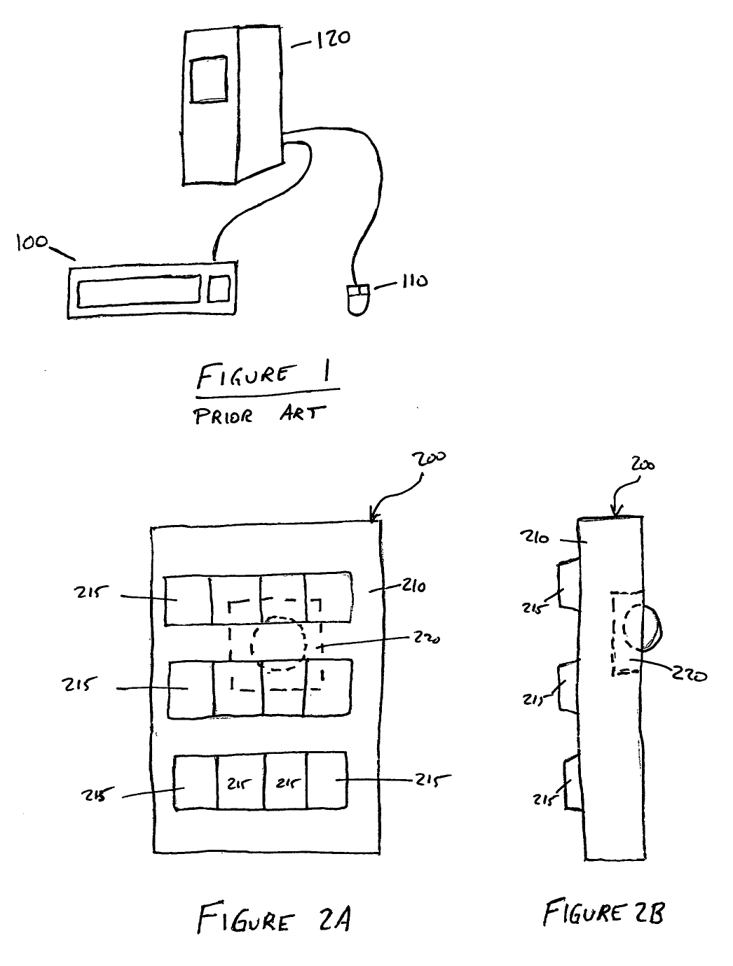

### DETAILED DESCRIPTION OF THE PRESENTLY PREFERRED EMBODIMENTS

The numerous innovative teachings of the present application will be described with particular reference to the presently preferred embodiment. However, it should be understood that this class of embodiments provides only a few examples of the many advantageous uses of the innovative teachings herein. In general, statements made in the specification of the present application do not necessarily delimit any of the various claimed inventions. Moreover, some statements may apply to some inventive features but not to others.

FIGS. 2A and 2B depict the top and side views, respectively, of the presently preferred embodiment 200 of the invention. A keyboard 210, having at least one key 215, has an integral motion-sensing device 220 that senses movement of the keyboard. In the preferred embodiment shown, the motion-sensing device 220 is a mouse-ball system such as that found in a conventional computer mouse. However, the motion-sensing device 220 could be a mechanical device, such as tilt-switches or a mouse system, an optical device, such as an optical mouse system or an infrared (IR) ranging/positioning system, or a radio-frequency (RF) ranging/positioning system. Some conventional mechanical mouse systems use a ball and x-y potentiometer or a ball and x-y optical sensor to sense movement in the x-y plane. One skilled in the art understands that motion-sensing device 220 could output data in analog and/or digital form.

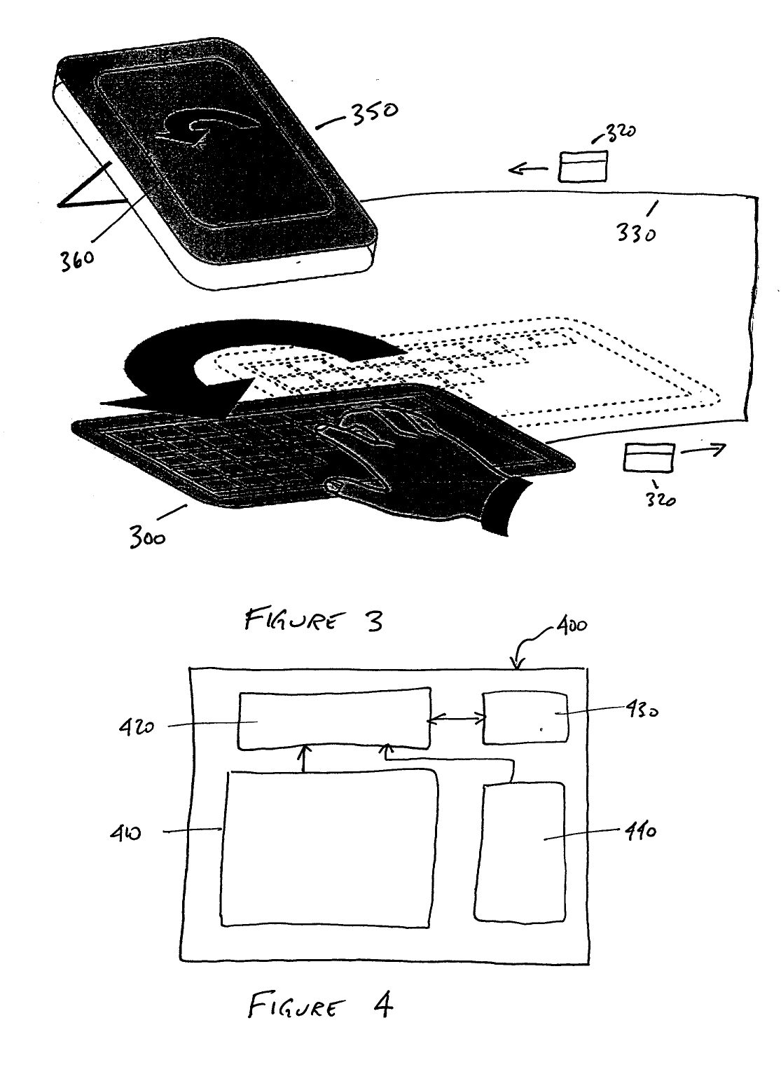

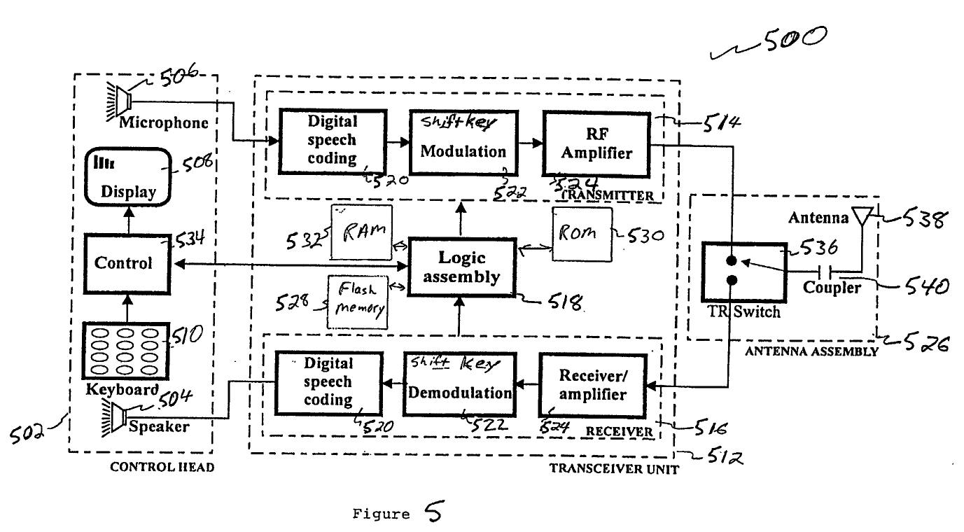

FIG. 3 shows the preferred embodiment of the innovative data input device as it might be used in a typical configuration. The innovative keyboard 300 functions as a remote data input terminal and is linked to a remote data-processing device 350, such as a mobile phone, personal digital assistant (PDA), or portable computer, via a communication link 330. The communication link 330 may be low power RF technology, such as Bluetooth, optical technology, such as infra-red (IR) communications, or a direct physical connection, such as a cable. When the keyboard 300 is moved, the motion-sensing device 310 generates data about the movement. The keyboard movement data 320 may then be transmitted over the communication link 330 to the remote data-processing device 350. The remote data-processing device 350 may use the keyboard movement data 320 to re-position an onscreen cursor 360, for example.

FIG. 4 depicts a block diagram of the presently preferred embodiment of the innovative data input device 400. A keypad assembly 410 is coupled to an input/output device 420. In this embodiment, the input/output device 420 is a low power RF transceiver. The input/output device 420 is further coupled to an antenna 430. A mouse assembly 440 may be coupled directly to the input/output device 420 or, alternatively, it may be coupled indirectly to the input/output device 420 via a coupling to the keypad 410.

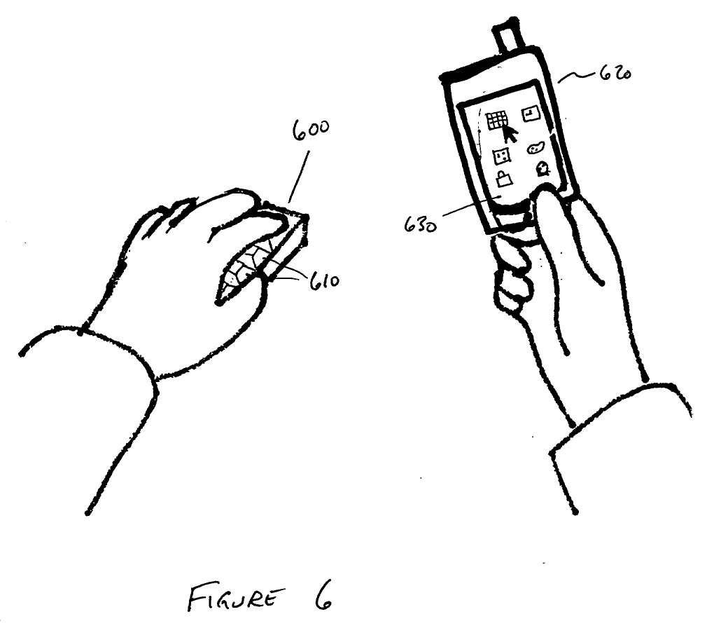

FIG. 5 depicts a block diagram of a mobile station 500 that can make use of the disclosed embodiments. Although the invention is discussed in the context of a mobile station for exemplary purposes, any suitable electronic device, such as a portable computer or PDA, may interact with the innovative data input device disclosed herein. The mobile station 500 includes, in this example:

A control head 502 containing an audio interface, i.e. a speaker 504 and microphone 506. The control head 502 generally includes a display assembly 508 allowing a user to see dialed digits, stored information, messages, calling status information, including signal strength, etc. The control head generally includes a keypad 510, or other user control device, allowing a user to dial numbers, answer incoming calls, enter stored information, and perform other mobile station functions. In the context of the disclosed invention, display assembly 508 is a graphical user interface. The control head also has a controller unit 534 that interfaces with a logic control assembly 518 responsible, from the control unit perspective, for receiving commands from the keypad 510 or other control devices, such as the disclosed invention, and providing status information, alerts, and other information to the display assembly 508;

A transceiver unit 512 includes a transmitter unit 514, receiver unit 516, and the logic control assembly 518. The transmitter unit 514 converts low-level audio signals from the microphone 506 to digital coding using a codec (a data coder/decoder) 520. The digitally encoded audio is represented by modulated shifts, for example, in the frequency domain, using a shift key modulator/demodulator 522. Other data received from the logic control assembly 518, such as station parameters and control information, may also be encoded for transmission. The modulated signal is then amplified by RF amplifier 524 and transmitted via an antenna assembly 526;

The antenna assembly 526 contains a TR (transmitter/receiver) switch 536 to prevent simultaneous reception and transmission of a signal by the mobile station 500. The transceiver unit 512 is connected to the antenna assembly 526 through the TR switch 536. The antenna assembly contains at least one antenna 538 coupled to TR switch 536 by coupler 540;

A receiver unit 516 receives a transmitted signal via the antenna assembly 526. The signal is amplified by receiver/amplifier 524 and demodulated by shift-key demodulator 522. If the signal is an audio signal, it is decoded using the codec 520. The audio signal is then reproduced by the speaker 504. Other signals, such as remote data input from the present invention are handled by the logic control assembly 518 after demodulation by demodulator 522; and

A logic control assembly 518 usually containing an application specific integrated circuit (or ASIC) combining many functions, such as a general purpose microprocessor, digital signal processor, and other functions, into one integrated circuit. The logic control assembly 518 coordinates the overall operation of the transmitter and receiver using control messages. The various disclosed embodiments would make use of the logic control assembly 518 to update the display 508. Generally, the logic control assembly 518 operates from a program that is stored in flash memory 528 of the mobile station. Flash memory 528 allows upgrading of operating software, software correction or addition of new features. Flash memory 528 is also used to hold user information such as speed dialing names and stored numbers.

In addition to flash memory 528, the mobile station 500 will typically contain read only memory (ROM) 530 for storing information that should not change, such as startup procedures, and random access memory (RAM) 532 to hold temporary information such as channel number and system identifier.

FIG. 6 shows a keypad 600 embodiment of the present invention as it might be used with a mobile station 620. Mobile station 620 has a display 630. A cursor 640 can be navigated around the display 630 by moving the entire keypad 600. Keys 610 on the keypad can be used to enter text or to select icons 650 on the display.

As will be recognized by those skilled in the art, the innovative concepts described in the present application can be modified and varied over a tremendous range of applications, and accordingly the scope of patented subject matter is not limited by any of the specific exemplary teachings given.

For example, the various embodiments have generally been discussed in the context of keypads or keyboards. One skilled in the art understands that the invention is equally applicable to keypads and keyboards. Therefore, for purposes of this application, the terms keypad and keyboard are considered synonymous.

For example, the invention has primarily been discussed in the context of a keyboard with an integral motion-sensing device. In one variation, a touchpad could be used rather than a keyboard.

For example, the integral motion-sensing device has primarily been discussed in the context of a mouse-like device that mechanically sense motion of the input device. In one variation, motion of the input device could be electronically sensed by triangulation of electromagnetic signals, similar to Global Positioning systems but with low-power RF, rather than by a mechanical mouse-like device.

As another example, the invention has been discussed primarily in the context of a remote data entry device for use with a mobile station. One skilled in the art realizes that the invention could be used with a mobile computer, PDA, a conventional desktop personal computer, and a multitude of other electronic devices.

What is claimed is:

1. A data input device, comprising:
a keypad; and
an integral motion-sensing device;
wherein said integral motion-sensing device is configured to generate data relating to the movement of said keypad.

2. The data input device of claim 0, wherein said integral motion-sensing device is a mouse.

3. The data input device of claim 0, wherein said integral motion-sensing device is configured to generate said data by signal triangulation.

4. The data input device of claim 0, wherein said integral motion-sensing device is configured to transmit said data to a remote electronic device.

5. A data input system, comprising:
a data input device;
a motion-sensing device, for sensing motion of said data input device;
a remote data processing device; and
a communication link coupling said data input device, said motion-sensing device, and said remote data processing device, whereby data may be transferred from said data input device or said motion-sensing device to said remote data processing device;
wherein said motion-sensing device is disposed within said data input device.

6. The data input system of claim 5, wherein said data input device is a keyboard, said keyboard having at least one key.

7. The data input system of claim 5, wherein said remote data processing device further comprises:
a display; and
a logic control assembly coupled to said communication link;
wherein said logic control assembly is configured to update said display in response to receiving data from said motion-sensing device.

8. The data input system of claim 5, wherein said communication link is an IR link.

9. The data input system of claim 5, wherein said communication link is a low-power RF link.

10. The data input system of claim 5, wherein said remote data processing device is a mobile communication device.

11. The data input system of claim 5, wherein said remote data processing device is a portable computer.

12. The data input system of claim 5, wherein said communication link is a cable comprising at least one wire.

13. A data input device, comprising:
a keypad device; and
a mouse, for sensing motion of said keypad device;
wherein said mouse is primarily disposed within said keypad device.

14. The data input device of claim 13, wherein said mouse senses motion of said keypad device and generates data related to said motion.

15. The data input device of claim 13, wherein said keypad device comprises at least one key.

16. The data input device of claim 13, wherein said keypad device further comprises:
a top side having keys;
a bottom side; and
said mouse is disposed toward said bottom side of said keypad device.

17. The data input device of claim 13, wherein said mouse is an optical mouse.

18. The data input device of claim 13, further comprising an input/output device coupled to said mouse;
whereby data from said mouse may be transmitted by said input/output device to a remote device.

19. The data input device of claim 18, wherein said input/output device is configurable to transmit data to a remote device.

20. The data input device of claim 19, wherein said input/output device is configurable to transmit said data in digital form.
